(19) United States
(12) Patent Application Publication
(10) Pub. No.: US 2004/0117817 A1
(43) Pub. Date: Jun. 17, 2004

(54) System and method for managing package service in digital cable broadcasting

(76) Inventors: Eun-Jung Kwon, Daejeon (KR); Han-Seung Koo, Daejeon (KR); Tae-Kyoon Kim, Daejeon (KR); Yong-Seong Cho, Daejeon (KR); Joon-Young Jung, Daejeon (KR); O-Hyung Kwon, Daejeon (KR); Chieteuk Ahn, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/420,282

(22) Filed: Apr. 22, 2003

(30) Foreign Application Priority Data
Dec. 12, 2002 (KR) 2002-79221

(51) Int. Cl. H04N 7/173; H04N 7/167; H04N 7/16

(52) U.S. Cl. 725/31; 725/30; 725/116; 725/146

(57) ABSTRACT

A package service management system and method in digital cable broadcasting comprises: a host having middleware for receiving broadcast signals of a headend and bidirectional service information, and executing a package application program for providing a package service; a POD for analyzing data, and decoding a package subscription and termination message using an encoded key so as to allow or disallow watching channels; and a headend for defining package-setting information, transmitting it to the host or the POD, generating entitlement test messages on a paid channel, transmitting them to the POD, and transmitting the subscriber's encoded key according to a request by the POD. Therefore, the subscriber can watch TV and remotely subscribe or terminate a paid package service, thereby increasing user's convenience.

### CROSS REFERENCE TO RELATED APPLICATION

This application is based on Korea Patent Application No. 2002-79221 filed on Dec. 12, 2002 in the Korean Intellectual Property Office, the content of which is incorporated herein by reference.

### BACKGROUND OF THE INVENTION

(a) Field of the Invention

The present invention relates to a system and method for managing a package service in digital cable broadcasting. More specifically, the present invention relates to a system and method for managing a packet service in digital cable broadcasting for remotely subscribing and terminating a paid package service by a subscriber.

(b) Description of the Related Art

FIG. 1 shows a general configuration of a digital cable TV broadcasting system.

As shown, the digital cable TV broadcasting system comprises a headend 10, a host 20, a POD (point of deployment) 30, and a television 40.

The headend 10 comprises an audio and video data encoding system, a subscriber management system, a POD system, an application server for providing a bidirectional service, and a system for producing broadcast signals using the above-noted information.

The host 20 receives the broadcast signals and the bidirectional service from the host 20. In this instance, an in-band channel network N1 for transmitting the broadcast signals and an out-of-band channel network N2 for providing additional information and bidirectional service information are provided between the headend 10 and the host 20.

The POD 30 analyzes data provided to the host 20 through the out-of-band channel network N2, and POD data. The TV 40 allows a user to watch application programs and broadcast programs of the host 20.

In the above, the POD 30 may be inserted into the host 20 so that the user may view paid services. When the POD 30 normally communicates with the host, a cable broadcasting service provider may provide an EAS (emergency alert system,) an interactive program guide, and IPPV (impulse pay per view,) a VOD (video on demand,) and an interactive service.

In general, a package service combines a plurality of channels into a single package, and provides it to subscribers. The package service increases profits of paid services by adding low-rated program channels to the package and selling the channel-added package. Therefore, the cable broadcasting service provider mainly uses package services for the paid services.

When the package services are provided to viewers with charges according to the business viewpoint of the cable broadcasting service provider, it is required to insert the POD 30 to the host.

However, when the cable broadcasting service provider provides a package service as free-of-charge additional service information, the host receives the package information, and accordingly, the user may subscribe to a package service when the POD 30 is not inserted into the host 20.

For reference, since the open cable standard provides the IPPV generic support on the paid service, the POD receives a message having any kind of a message format from the headend to analyze the same.

The host reads the message analyzed by the POD, and when a subscriber confirms his purchase intention through a TV screen, the host allows him to remotely request a purchase of an IPPV program.

However, even though many cable broadcasting service providers use the package service, the subscriber cannot remotely request or terminate the package service.

Also, a process for requesting and checking package service information between the host and the POD is not needed in the case of transmitting the package service information to the host, but a method for the POD to receive an encoded key from the POD system of the headend is required.

### SUMMARY OF THE INVENTION

It is an advantage of the present invention to provide a system and method for managing a package service in digital cable broadcasting for a subscriber to remotely subscribe and terminate package services provided by a cable broadcasting service provider, and thereby increase the subscriber's convenience.

In one aspect of the present invention, a package service management system comprises: a headend unit for collecting various kinds of information and forming the same into broadcast signals; a host for receiving the broadcast signals of the headend unit and bidirectional service information, and executing a package application program for providing a package service; a POD (point of deployment) for analyzing data received through an in-band channel or an out-of-band channel, and POD data, and decoding the message on the package subscription and termination by using a channel encoding key so as to allow or disallow the subscriber to watch channels that configure a corresponding package; a manager unit for configuring the package-related information into package-setting information, transmitting it to the host or the POD, and recording package service information subscribed by the subscriber to use it as billing information; and a POD unit for generating an ECM (entitlement control message) and an EMM (entitlement management message) on paid channels for each channel using the manager unit to transmit them to the POD through the headend unit, and transmitting a subscriber's encoded key when the POD requests it.

In another aspect of the present invention, a package service management method in digital cable broadcasting comprises: (a) a headend defining package-related information as package-setting information, setting a package application program for providing the package service, and the package-setting information to fit them to a transmission protocol standard, and transmitting them to a host; (b) the host receiving the package application program and the package-setting information in (a), executing the package application program, and loading the package-setting information to the package application program; (c) a POD requesting an encoded key for decoding an EMM (entitlement management message) from the headend so that the subscriber may watch the package-setting information and request subscription or termination of a package through (b); and (d) the headend transmitting the corresponding subscriber's encoded key to the POD according to the request in (c) to allow/disallow the subscriber to view a channel according to the subscription/termination of the package service by the subscriber.

In still another aspect of the present invention, a package service management method comprises: (a) a headend defining package-related information as package-setting information, setting the package-setting information to fit to a network interface standard, and transmitting it to a POD; (b) the POD filtering package-setting information through (a), and using the package application program interfaced with and executed by the host to transmit the package-setting information to the host; (c) a POD requesting an encoded key for decoding an EMM (entitlement management message) from the headend so that the subscriber may watch the package-setting information and request subscription or termination of a package through (b); and (d) the headend transmitting the corresponding subscriber's encoded key to the POD according to the request in (c) to allow/disallow the subscriber to watch a channel according to the subscription/termination of the package service by the subscriber.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a general configuration of a digital cable TV system;

FIG. 2 shows a block diagram of a package service management system in digital cable broadcasting according to a preferred embodiment of the present invention;

FIG. 3 shows a process for subscribing and terminating a package service when package-setting information is transmitted to the host in the package service management method in digital cable broadcasting according to a first preferred embodiment of the present invention;

FIG. 4 shows a process for subscribing and terminating a package service when package-setting information is transmitted to the POD in the package service management method in digital cable broadcasting according to a second preferred embodiment of the present invention; and

FIG. 5 shows a resource usage process between a host for package application programs and a POD.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

FIG. 2 shows a block diagram of a package service management system in digital cable broadcasting according to a preferred embodiment of the present invention.

As shown, the package service management system comprises a headend unit 110, a host 120, a POD 130, a manager unit 140, and a POD unit 150.

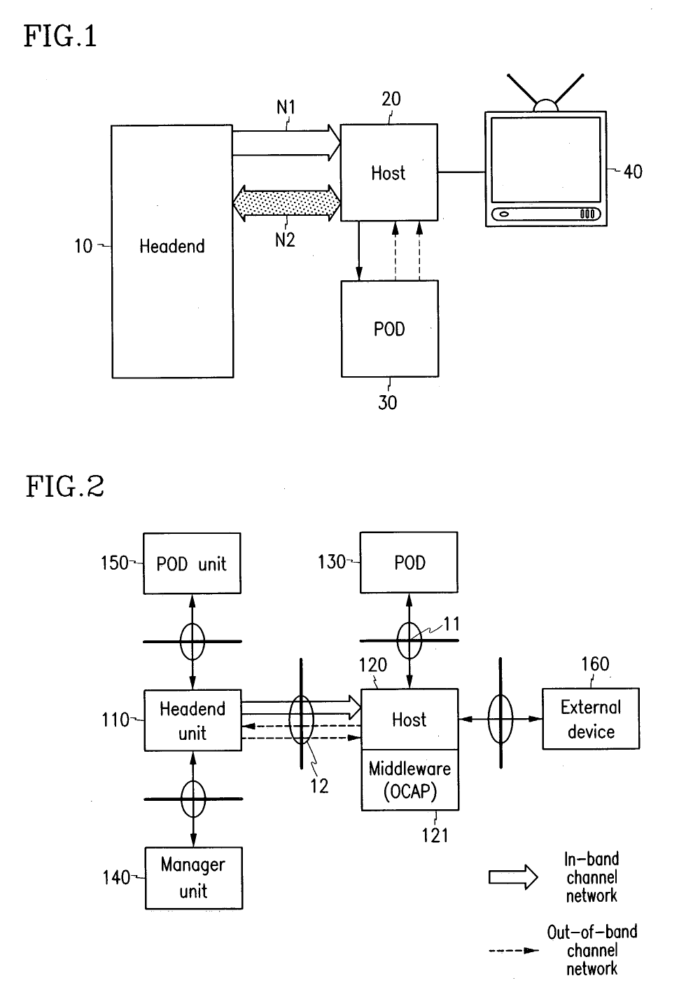

Descriptions on the headend unit 110, the host 120, and the POD 130 matched with those shown in FIG. 1 will be omitted. The reference numeral 11 represents an interface between the POD and the host, and the reference numeral 12 shows a network interface.

Also, the headend unit 110, the manager unit 140, and the POD unit 150 represent functions of the headend realized into three units.

The manager unit 140 defines package-setting information using package-related information, and transmits the package-setting information to one of the host 120 and the POD 130. The manager unit 140 records paid service information subscribed to by the subscriber, for example, information on package service subscription and termination, and uses it as billing information.

In this instance, the package-setting information includes a package name, a package ID, a package type, a price, a service period, a number of channels or programs configuring the package, and a name of the channels or the programs.

The POD unit 150 uses the manager unit 140 to generate an ECM (entitlement control message) and an EMM (entitlement management message) on a paid channel for each channel, and uses an in-band channel and an out-of-band channel to transmit the messages to the POD 130 through the headend unit 110.

Since broadcast signals transmitted through the in-band channel and additional information transmitted through the out-of-band channel are transmitted to the host 120 in which middleware 121 is installed, the subscriber may watch the broadcast signals through an external device 160 such as a TV.

Since scrambled broadcast signals are transmitted to the host 120 in the case of a paid broadcast, the POD 130 requests an encoded key from the POD unit 150 so as to analyze the scrambled broadcast signals.

The POD unit 150 transmits the corresponding subscriber's encoded key to the POD 130 according to a request of the encoded key by the POD 130.

In this instance, it is required for the host 120 and the POD 130 to be interfaces so as to filter the data transmitted according to Si (service information) and a viewpoint of a cable broadcasting service provider.

In the above, the package-setting information defined by the manager unit 140 and a package application program for a package service are transmitted to the subscriber's host 120 by selecting one of protocols defined to SCTE DVS 161r2 (ATSC data broadcast standard A/90) from among transmission protocols of the OCAP (open cable application platform) that is a data broadcast standard of the open cable.

In another way, the cable broadcasting service provider defines a message format and transmits the package-setting information to the POD 130, and in this instance, the middleware 121 of the host 120 executes a package application program.

An operation of the package service management system in the digital cable broadcasting according to a preferred embodiment of the present invention will be described with reference to drawings.

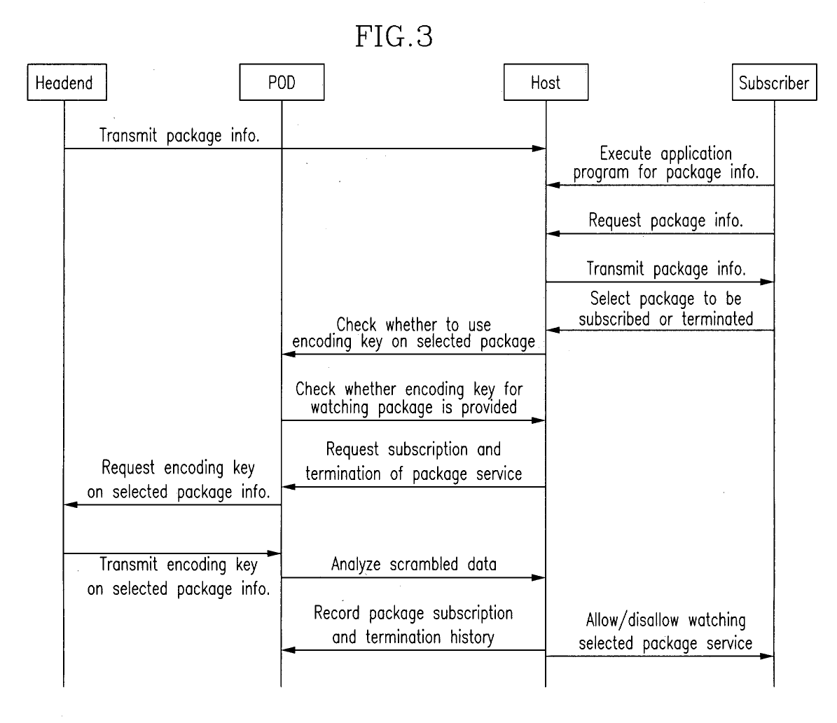

FIG. 3 shows a process for subscribing and terminating a package service when package-setting information is transmitted to the host in the package service management method in digital cable broadcasting according to a first preferred embodiment of the present invention.

As shown, the manager unit 140 transmits the package-setting information together with a package application program for providing a package service according to a transmission protocol of the OCAP that is a standard of the middleware 121 of the digital cable TV broadcasting to the host 120.

Through information request and transmission between the subscriber and the host 120, the host 120 executes a package application program to the subscriber's external device 160, that is, a TV screen, and the subscriber loads package information on the package application program to subscribe or terminate a desired package.

In this instance, when the package application program has a priority higher than that of the package-setting information, the manager unit 140 stores the package application program in a non-volatile memory of the host 120, and receives the package application program from the host each time the package-setting information is modified.

When the cable broadcasting service provider does not set a priority of the package application program higher than the package-setting information, the manager unit 140 transmits a package application program including package-setting information to the host 120 each time the host 120 is powered on.

That is, the host 120 navigates information downloaded to the TV screen of the subscriber to select or terminate the corresponding package when the cable broadcasting service provider transmits the package-setting information and the application program to the host through any methods.

When the subscriber selects package-setting information, the POD 130 requests an encoded key from the POD unit so as to decode the EMM that allows viewing a paid service.

When the subscriber requests to terminate a package service, the POD 130 checks (p.12) whether the corresponding package is already provided to the subscriber. That is, the POD 130 checks whether the POD 130 stores an encoded key on the termination-selected package.

In this instance, when storing the encoded key, the POD 130 requests an encoding key for expiring the encoded key from the POD unit 150.

The POD 150 transmits the subscriber's encoding key requested by the POD 130 to an out-of-band channel.

Therefore, the POD 130 receives the encoding key from the POD unit 150 to expire the service period for decoding the corresponding package, and prevent viewing of the channels forming the package.

When the subscriber requests a subscription of the package service, the POD 130 and the POD unit 150 transmit and receive the subscriber's encoded key, and the POD 130 decodes the EMM for viewing package service information.

After this, the POD 130 obtains a channel-encoding key to finally decode the channel key that encodes a CW (control word) transmitted to the in-band channel, and obtain the CW.

Therefore, the POD 130 analyzes the scrambled CW-inserted broadcasting signals transmitted to the host 120 so that the subscriber may view the channels forming the package.

Also, the POD 130 records a purchase history of a package number so that the manager unit 140 may utilize a package purchase history stored in the POD 130 at the time of settling the billed price.

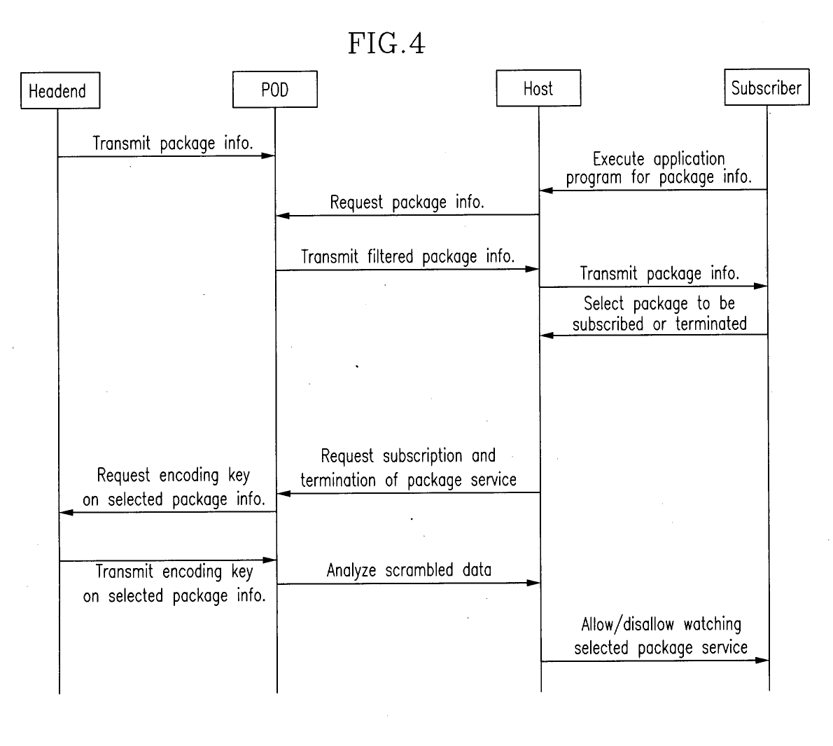

FIG. 4 shows a process for subscribing and terminating a package service when package-setting information is transmitted to the POD in the package service management method in digital cable broadcasting according to a second preferred embodiment of the present invention.

As shown, the manager unit 140 configures package-setting information to fit the network interface of the digital cable TV broadcasting and transmits it to the POD 130.

The POD 130 filters the transmitted package-setting information, and a package application program executed by the middleware 121 of the host 120 displays the package-setting information to the subscriber.

In this instance, the interface between the POD 130 and the host 120 uses resources for the SAS (specific application support) of OC-SP-HOSTPOD-IFI-10-020524 that is the interface standard of the host and the POD of the open cable standard, and encapsulates package-setting information and an application target to support communication between the host and the POD.

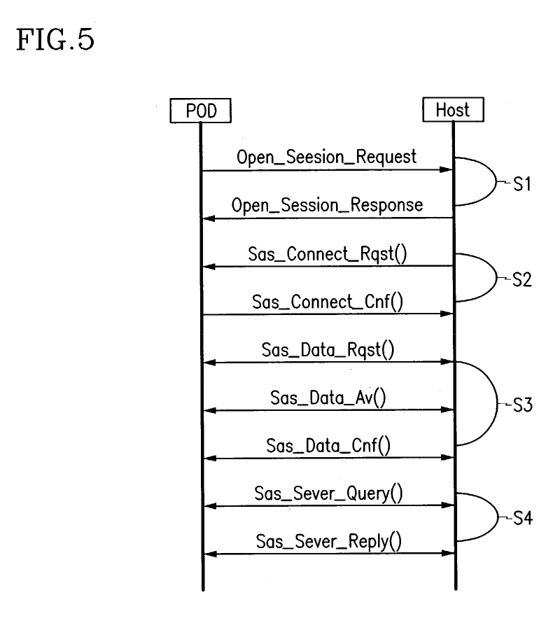

FIG. 5 shows a resource usage process between a host for package application programs and a POD.

As shown, in a communication method between the host and the POD using the SAS, a session is formed by Open_Session_Request and Open_Session_Response between the host and the POD in S1.

After this, when the host and the POD are connected by Sas_Connect_Rqst and Sas_Connect_Cnf in S2, it is checked by Sas_Data_Rqst, Sas_Data_Av, and Sas_Data_Cnf whether a preparation for processing data is finished in S3.

When the preparation for processing the data between the host and the POD is finished through S3, the host queries package-setting information transmitted by the headend to the POD through Sas_Sever_Query and Sas_Sever_Reply in S4.

In this instance, the package-setting information queried by the host from the POD is displayed to the subscriber by an application program executed by the middleware 121.

The subscriber subscribes or terminates a desired package service through the TV screen as shown in FIG. 3.

The package service management system and method in the digital cable broadcasting according to the preferred embodiments of the present invention allows the subscriber who has a bidirectional terminal having middleware 121 installed therein to watch TV and remotely subscribe or terminate a paid package service, thereby increasing the user's convenience.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A package service management system comprising:
a headend unit for collecting various kinds of information and forming the same into broadcast signals;
a host for receiving the broadcast signals of the headend unit and bidirectional service information, and executing a package application program for providing a package service;
a POD (point of deployment) for analyzing data received through an in-band channel or an out-of-band channel, and POD data, and decoding the message on the package subscription and termination by using a channel encoding key so as to allow or disallow the subscriber to watch channels that configure a corresponding package;
a manager unit for configuring the package-related information into package-setting information, transmitting it to the host or the POD, and recording package service information subscribed by the subscriber to use as billing information; and
a POD unit for generating an ECM (entitlement control message) and an EMM (entitlement management message) on paid channels for each channel using the manager unit to transmit them to the POD through the headend unit, and transmitting a subscriber's encoded key when the POD requests it.

2. The system of claim 1, wherein the host includes middleware for executing the package application program.

3. The system of claim 1, wherein the manager unit has the package-setting information including a package name, a package ID, a package type, a price, a service period, a number of channels or programs forming the package, and a name of the channels or the programs.

4. The system of claim 1, wherein the host is connected to an external device for viewing the broadcast signals, executes the package application program to a screen, and loads package information to the package application program so that the subscriber may subscribe or terminate a package desired by the subscriber.

5. The system of claim 1, wherein the manager unit transmits the package-setting information and the package application program to the host.

6. The system of claim 5, wherein when transmitting the package-setting information to the host, the manager unit sets a priority of the package application program higher than that of the package-setting information to store the package application program in the host, and reads the package application program stored in the host when the package-setting information is modified.

7. The system of claim 5, wherein the manager unit sets a priority of the package-setting information higher than that of the package application program, and transmits the package application program including the package-setting information to the host when the host is powered on.

8. The system of claim 7, wherein the manager unit transmits an AIT (application information table) to the host through an in-band channel, or transmits package-setting information updated through application program signaling for a recently updated package service by configuring an XAIT to a descriptor of SI (service information) to the host though an out-of-band channel.

9. The system of claim 1, wherein when the manager unit transmits the package-setting information to the POD, the POD filters package-setting information to transmit it to the package application program executed by the host.

10. The system of claim 9, wherein the POD and the host uses an SAS (specific application support) resource to transmit and receive data.

11. The system of claim 1, wherein the POD requests an encoded key for decoding the EMM from the POD unit in order for a subscriber to subscribe or terminate package service information, and the POD unit transmits the encoded key subscribed by the subscriber to the POD through an out-of-band channel according to a request by the POD.

12. The system of claim 11, wherein when the subscriber subscribes while watching package service information, the POD receives an encoded key from the POD unit to decode the EMM, and analyzes scrambled broadcast signals into which a CW (control word) is inserted so that the subscriber may watch the broadcast signals.

13. The system of claim 11, wherein when the subscriber terminates watching the package service information, the POD receives the encoded key from the POD unit and expires a period for decoding the corresponding package.

14. The system of claim 1, wherein the POD stores a package purchase history of a package number, and allows the manager unit to use the package purchase history when the manager unit settles billing.

15. A package service management method in digital cable broadcasting, comprising:
(a) a headend defining package-related information as package-setting information, setting a package application program for providing the package service, and the package-setting information to fit them to a transmission protocol standard, and transmitting them to a host;
(b) the host receiving the package application program and the package-setting information in (a), executing the package application program, and loading the package-setting information to the package application program;
(c) a POD requesting an encoded key for decoding an EMM (entitlement management message) from the headend so that the subscriber may watch the package-setting information and request subscription or termination of a package through (b); and
(d) the headend transmitting the corresponding subscriber's encoded key to the POD according to the request in (c) to allow/disallow the subscriber to view a channel according to the subscription/termination of the package service by the subscriber.

16. The method of claim 15, wherein the headend transmitting package-setting information to the host in (a) comprises: when the package application program has a priority higher than that of package-setting information, the host storing the package application program, and reading the stored package application program when the package-setting information is modified.

17. The method of claim 15, wherein the headend transmitting package-setting information to the host in (a) comprises: when the package-setting information has a priority higher than that of the package application program, the headend transmitting the package application program including the package-setting information to the host each time the host is powered on.

18. The method of claim 17, wherein when transmitting the package application program including the package-setting information to the host, the headend transmits an AIT (application information table) to the host through an in-band channel, or configures an XAIT to a descriptor of SI (service information) to transmit package-setting information updated through application program signaling for a recently updated package service to the host through an out-of-band channel.

19. A package service management method comprising:
(a) a headend defining package-related information as package-setting information, setting the package-setting information to fit to a network interface standard, and transmitting it to a POD;
(b) the POD filtering package-setting information through (a), and using the package application program interfaced with and executed by the host to transmit the package-setting information to the host;
(c) a POD requesting an encoded key for decoding an EMM (entitlement management message) from the headend so that the subscriber may watch the package-setting information and request subscription or termination of a package through (b); and
(d) the headend transmitting the corresponding subscriber's encoded key to the POD according to the request in (c) to allow/disallow the subscriber to watch a channel according to the subscription/termination of the package service by the subscriber.

20. The method of claim 19, wherein the POD interfacing with the host in (b) comprises using an SAS (specific application support) resource to support communication between the host and the POD.

21. The method of claim 19, wherein the POD interfacing with the host in (b) comprises:
(i) checking whether a preparation for processing data is finished, when a session is formed between the POD and the host and they are connected;
(ii) the host querying package-setting information transmitted by the headend from the POD when the preparation is finished in (i); and
(iii) the POD providing the package-setting information to the package application program executed by the host according to the query from the host in (ii) so that the subscriber may watch the package-setting information.

22. The method of claim 15, wherein, in defining package-setting information in (a), the package-setting information comprises a package name, a package ID, a package type, a price, a service period, a number of channels or programs forming the package, and a name of the channels or the programs.

23. The method of claim 15, wherein the host executing the package application program in (b) comprises: executing the package application program to a screen of an external device connected to the host so that the subscriber may watch package-setting information.

24. The method of claim 15, wherein the POD in (d) stores the subscriber's purchase history on the package service and uses the same at the time of settling the charged price.

25. The method of claim 15, wherein the subscriber subscribing the package service in (d) comprises: the POD using an encoded key transmitted from the headend to decode an EMM (entitlement management message), and analyzing scrambled broadcast signals of a channel forming an encoded package so that the subscriber may watch the broadcast signals.

26. The method of claim 15, wherein the subscriber terminating the package service in (d) comprises: the POD using the encoded key transmitted from the headend to expire a service period for decoding the corresponding package and disallow watching the channel forming the package.
